(19) United States
(12) Patent Application Publication
(10) Pub. No.: US 2013/0018779 A1
(43) Pub. Date: Jan. 17, 2013

(54) ALIAS-BASED MERCHANT TRANSACTION SYSTEM

(71) Applicants: MARIE B. LAQUERRE, Matthews, NC (US); JOHN F. TUDERS, Charlotte, NC (US); KEVIN THOMAS CHURCH, Matthews, NC (US); JON R. WOLF, Charlotte, NC (US); ROBERT E. WILSON, Coppell, TX (US)

(72) Inventors: MARIE B. LAQUERRE, Matthews, NC (US); JOHN F. TUDERS, Charlotte, NC (US); KEVIN THOMAS CHURCH, Matthews, NC (US); JON R. WOLF, Charlotte, NC (US); ROBERT E. WILSON, Coppell, TX (US)

(73) Assignee: BANK OF AMERICA CORPORATION, Charlotte, NC (US)

(21) Appl. No.: 13/342,076

(22) Filed: Jan. 1, 2012

Related U.S. Application Data
(60) Provisional application No. 61/507,839, filed on Jul. 14, 2011.

(51) Int. Cl. G06Q 40/02

(52) U.S. Cl. 705/39

(57) ABSTRACT

A system and method for using an alias to conduct financial transactions at a merchant is provided. The system and method allows a user to provide an alias identifying the user or a business in order to conduct transactions without needing to know or provide actual account numbers. Aliases are associated with users and businesses and can be linked to financial accounts of the user and business. When the method determines that the user is attempting to conduct a transaction using the alias, the method determines the account number associated with the alias and completes the transaction using the alias. The method may also evaluate the transaction to determine whether pre-determined rules are complied with and provide confirmation to the user that the transaction has completed.

### CLAIM OF PRIORITY UNDER 35 U.S.C. §119

The present Application for Patent claims priority to Provisional Application No. 61/507,839, entitled “SYSTEM AND METHOD FOR USING AN ALIAS TO CONDUCT FINANCIAL TRANSACTION AT A MERCHANT” filed Jul. 14, 2011, and assigned to the assignee hereof and hereby expressly incorporated by reference herein.

### BACKGROUND

With the wide adoption of credits cards, debit cards, electronic payment devices, online shopping systems, and online banking systems, very few people today carry a lot of cash or write many checks. However, people still need to transfer money with businesses for all sorts of reasons. For example, a person may want to purchase something in a store or a person may want to receive a refund when returning a purchase. Giving or receiving money from a business, however, can be difficult when you don't have cash on hand. The process may involve going to an automated teller machine (ATM) or writing the business a check, both of which can be time consuming and inconvenient depending on the situation.

Money can be transferred to a business using electronic banking systems, but these systems traditionally require that the sender provide account information to the business in order to instruct the bank to transfer money to the proper account. Most people do not know their own account numbers, nor do most people want to widely publicize their account numbers for security reasons.

Some third party service providers try to facilitate payments from one person to another, but many people do not like these systems because they require opening yet another account with another online entity, remembering yet another username and password, and disclosing confidential financial institution account information to these other companies. In addition to the inconvenience and the security concerns, these systems generally take time to set up and are not user-friendly.

For all these reasons and others, there is a need for improved user-friendly systems and methods for transferring money between individuals and businesses, especially if such systems can transfer money directly to and/or from financial institution accounts, such as demand deposit accounts (e.g., checking accounts), savings accounts, and/or credit accounts.

### BRIEF SUMMARY

Embodiments of the present invention address these and/or other needs by providing an innovative person-to-merchant (P2M) payment system along with a user-friendly interface and process for sending and receiving P2M payments. Advantageously, embodiments of the invention do not necessarily require users to share confidential account information with others in order to send and receive payments. In fact, embodiments of the invention do not require that the payment sender know any information about the financial accounts of the intended payment recipient. Furthermore, embodiments of the invention enable users to make payments to businesses that are not associated with the same financial institution and to businesses that are not associated with any financial institution. In a still further embodiment, a merchant is able to transfer the merchant's payment details to a user without requiring that any confidential financial account information be transferred.

More specifically, embodiments of the invention allow an entity to transfer funds to a business using the business name, category and location, picture, logo, brand, graphic art, and/or other alias of the business. The assignee of the present application describes some embodiments of such an invention in U.S. Provisional Patent Application No. 61/410,085, filed Nov. 4, 2010, which is incorporated herein by reference. The assignee of the present application describes some further embodiments of such an invention in U.S. Provisional Patent Application No. 61/410,087, filed Nov. 4, 2010, which is incorporated herein by reference. The assignee of the present application describes some still further embodiments of such an invention in U.S. Provisional Patent Application No. 60/991,172, filed on Nov. 29, 2007, and co-pending U.S. patent application Ser. No. 12/038,177, filed on Feb. 27, 2008, as well as in U.S. patent application Ser. Nos. 12/881,071, 12/881,073, 12/881,074, and 12/881,080 continuing therefrom; all of which are incorporated herein by reference. Embodiments of the present invention include and build off of those earlier embodiments to provide an improved P2M payment system and a more user-friendly, secure, and convenient user interface and method.

As described in greater detail below, the user interface can be incorporated into a mobile banking application for a bank or other financial institution. The user can use the mobile banking application or a website to register a mobile phone number, email address, or other alias by associating the number, address, or other alias with one of the user's financial institution accounts. This association is then stored in a data repository that can later be accessed by the mobile device, business, bank, and/or other financial institutions. Some embodiments of the invention provide a system for verifying that the alias is owned, held, or otherwise associated with the user. In an embodiment, the user is able to conduct a transaction at a business by providing the user's alias to the business.

The mobile banking application can also be used to initiate transfers to businesses using aliases. In some embodiments of the invention, a user can identify a transfer recipient by entering the business's alias (e.g., business name, business category, logo, brand, graphic art, URL address, etc.). The user can then create a transfer request by using the banking application to select an account associated with the user's banking account, enter or select the alias of the saved business, and complete the transaction. The banking system then accesses the data repository to determine whether the alias is registered and thereby associated with a financial institution account. If the alias is registered, the banking system sends a transfer notification to the business using the alias and/or initiates the funds transfer. If the alias is not registered, then the banking system uses the alias to send the business a notification (e.g., a text message, email, or the like) informing the business that there is a pending transfer that will be processed if the business registers its alias with an existing financial institution account and/or opens a new financial institution account. The notification then provides a link to the banking website or a mobile banking application that allows the business to easily register an existing account or open a new account.

Embodiments of the invention also provide a user interface that makes it easy for users to monitor their current, future, pending, and past person-to-merchant (P2M) and/or merchant-to-person (M2P) funds transfers as well as their saved transfer recipient list, alias registrations, incoming transfers, and/or other related information.

It should be appreciated that at least some embodiments of the invention provide a more convenient, user friendly, and secure P2M payment system that is provided by the user's bank through the bank's banking application with which the user is already familiar. In at least some embodiments, the user may not need to share personal or confidential information, such as account information, with people or businesses outside of the user's bank. The user can feel more secure having P2M services handled by their bank and having the convenience of being able to directly send money from and/or receive money into the user's financial institution accounts.

In an embodiment, a computer-implemented method for conducting a financial transaction at a merchant is provided. In some embodiments, the method comprises receiving an alias, wherein the alias is associated with a party to the transaction. The party can be a user, such as a bank customer, or a merchant. The computer-implemented method determines, via a computing device processor, an account associated with the alias. The computing device processor can be associated with a financial institution, can be associated with the merchant, or can be present in the user's mobile device. After determining an account associated with the alias, the computer-implemented method conducts the financial transaction between the user and the merchant using the account. In some embodiments, the computer-implemented method determines a financial account number associated with the account and conducts the transaction using the financial account number.

In some embodiments, the alias is associated with the merchant. For example, the user may provide the merchant's trademarked name as an alias. The computer-implemented method receives the alias and determines if the alias is associated with an account of the merchant. The alias may be a trademark, a social networking ID, a business category, a business location, a business name, a logo, a trade name, a service mark, a URL associated with a business, or the like. In an embodiment, the computer-implemented method provides the alias for the merchant based at least in part on the user's location. In some embodiments, the user assists the identification of the alias by inputting a business category or name. For example, the user's location may be determined using a positioning system device (e.g., a GPS unit) and the computer-implemented method may determine the alias of the business present at that location. In a still further embodiment, the merchant provides the merchant's alias and, optionally, transaction details to the user's mobile device. For example, a transponder at the merchant may wirelessly sync with the user's mobile device and transfer the merchant alias to the device. The user accepts the merchant alias by entering a passcode or tapping a touchscreen to authorize and/or finalize the transaction.

In further embodiments, the alias is associated with the user. The user may provide an alias so that the user does not need to provide the user's actual account number, with all the risks that entails, to the merchant. The user may provide the user's alias via a card, similar to a credit card, that has the user's alias embedded on a magnetic strip, on a computer chip, or printed on the card. In another embodiment, the user's alias is provided via an application on a mobile device, wherein the application is able to generate bar codes that encode the user's alias. The user presents the card or mobile device to the merchant, who then scans the alias to conduct the transaction. The merchant may send the alias and the amount to the financial institution, where the alias is associated with an account, and the transaction is completed. In an embodiment, the user and/or the merchant receives a notification that the transaction completed, such as via text message or through standard transaction processing channels.

In still further embodiments, the computer-implemented method determines characteristics of the transaction. For example, the computer-implemented method may determine the amount of the transaction, the amount remaining in the account if the transaction is processed, the location, date, or time of the transaction, or other details of the transaction. In an embodiment, the characteristics of the transaction are presented to the user. In a still further embodiment, the computer-implemented method determines whether the transaction complies with a pre-determined rule. For example, the computer-implemented method may determine whether a transaction may be processed based on the amount of the transaction, the time of the transaction, or the remaining balance of the account if the transaction is completed. If the transaction does not comply with the pre-determined rule, the transaction may be cancelled or require enhanced authorization procedures.

In an embodiment, a computer program product for conducting a financial transaction at a merchant is provided. In some embodiments, the computer program product comprises a computer-readable medium having computer-executable instructions. The computer executable instructions are configured to cause a computer to receive an alias, wherein the alias is associated with a party to the financial transaction. The party may be a user or a merchant. The computer-implemented method determines, via a computing device processor, an account associated with the alias and conducts a financial transaction between the user and the merchant using the account. The computer executable instructions may also determine the location of the user, which may be used in determining an alias for the business the user is visiting. The computer executable instructions may also determine the account balance remaining in the financial account if the transaction is completed, and in some embodiments provides the remaining balance to the user prior to completing the transaction. This assists the user in determining whether the transaction should be cancelled. In some embodiments, the computer executable instructions also determine whether the transaction complies with pre-determined rules. For example, the user, business, or financial institution may determine rules related to P2M transfers, such as maximum amounts or the like, that must be met before the transaction can be completed via alias.

In an embodiment, a system for conducting a financial transaction at a merchant is provided. In some embodiments, the system comprises a computer apparatus including a process and memory; and a payment system module stored in the memory and executable by the processor. The payment system module is configured to receive an alias, wherein the alias is associated with a party to the transaction; determine, via a computing device processor, an account associated with the alias; and conduct a financial transaction between the user and the merchant using the account. In some embodiments, the payment system module comprises an application on a mobile device of the user. The mobile device may be a mobile computing device, a mobile phone, a personal digital assistant, or the like. In a further embodiment, the system comprises a positioning system device on a mobile device of the user. In some embodiments, the system comprises wireless technology such as an NFC chip or wireless transmitter and/or receiver for communicating the alias between the user and the merchant.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 is a flowchart for a method for making P2M payments in accordance with an embodiment of the invention;

FIG. 2 is a block diagram illustrating the various ways through which a user may make P2M payments in accordance with various embodiments of the invention;

FIG. 3 provides a block diagram illustrating a P2M payment system and environment in accordance with embodiments of the invention;

FIG. 4 provides a block diagram illustrating the user's mobile device of FIG. 3 in accordance with an embodiment of the invention;

FIG. 5 provides a block diagram illustrating the alias data repository of FIG. 3 in accordance with an embodiment of the invention;

FIG. 6 provides a block diagram illustrating the financial institution's banking system of FIG. 3 in accordance with an embodiment of the invention;

FIGS. 7A-7C provide flow charts illustrating a process for sending P2M payments to a business using the business's alias in accordance with embodiments of the invention; and

FIG. 8 provides a flow chart illustrating a process for sending P2M payments by providing the user's alias in accordance with embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “bank,” “financial institution,” or “financial entity” include any organization that processes financial transactions including, but not limited to, banks, credit unions, savings and loan associations, investment companies, stock brokerages, asset management firms, insurance companies and the like. In specific embodiments of the invention, use of the term “bank” is limited to a financial entity in which account-bearing users conduct financial transactions, such as account deposits, withdrawals, transfers and the like.

Embodiments of the present invention provide a system and method for mobile banking integrated person-to-merchant (P2M) payments. Embodiments of the invention allow users of a financial entity to make payments directly from their accounts, whether their accounts be checking, savings, line of credit, credit card, and/or other accounts, to a business, including small business users and national-scale business users, without having to share any confidential account information and without having to know account information for the intended recipient. Embodiments of the invention also allow users to receive payments from businesses directly into their financial institution accounts without requiring the user to share account information with the business. It should be noted that some embodiments of the invention allow a user to make payments to and/or receive payments from another person in the same way that a user can make payments to and/or receive payments from a business. As such, as used herein, the phrase person-to-merchant (P2M) is intended to include person-to-person (P2P), merchant-to-merchant (M2M), and merchant-to-person (M2P) unless specifically stated otherwise. Moreover, embodiments of the present invention permit a sender to send money from the sender's financial institution account directly to the business's financial institution account using the alias of the business without the involvement of an intermediary or a third party. This allows for greater security as no party apart from the sender, the business, and the financial institution is ever a part of the transfer.

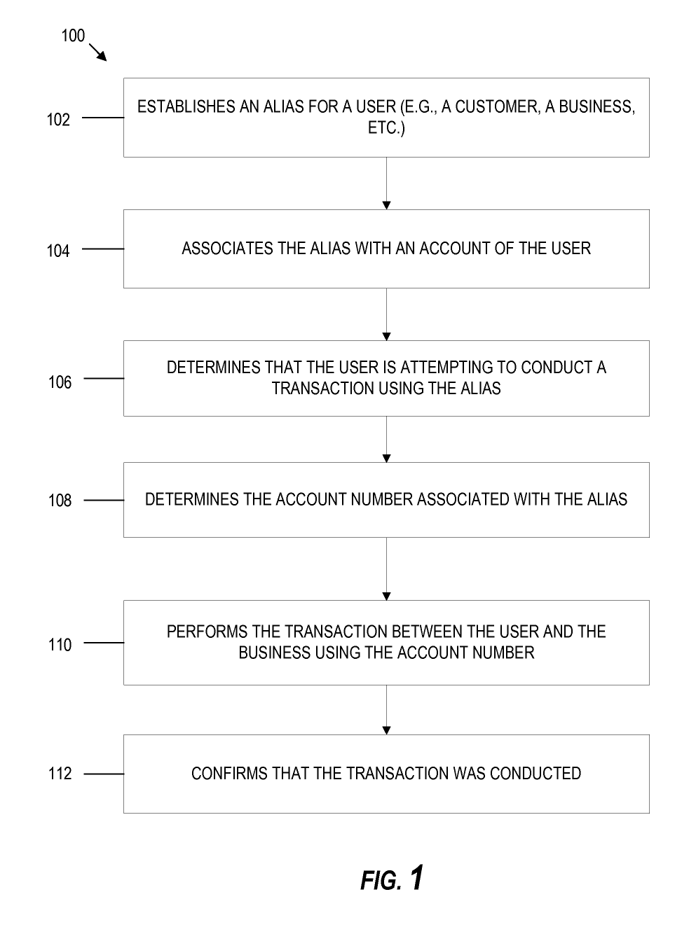

FIG. 1 is a flowchart providing an overview of a system and a computer-implemented method 100 for making P2M payments, in accordance with one or more embodiments of the invention. A user with an eligible account, e.g., checking (demand deposit account or “DDA”), savings, money market, line of credit, credit card, etc., is able to register and make use of this service. During the registration process, the user is able to set up an alias identifier (ID) (or simply an “alias”) that maps back to the user's account. The alias may be any unique identifier other than the user's financial institution account number. Typically, the alias is an identifier that friends, family, and/or other members of the public uniquely associate with the user. For example, the alias may be a mobile telephone number, an email address, a social networking ID, and/or the like. In some embodiments, the user is an individual customer of the financial institution. In some embodiments, the user is an organization, such as a non-profit entity or small business. In further embodiments, the user is a merchant associated with the financial institution.

In some embodiments, an alias for a business is related to the business name, business category, business location, logo, trade name, trademark, picture, brand, graphical art, URL address, or any other textual, graphical, or visual indicator of the business that would be known to the public. Businesses wish to make it easy for users to pay them and will want aliases that are understood by the public. For example, a business that has registered a trademarked name or slogan will want to continue to associate that trademarked name with the business. In another embodiment, a general business category is used and the computer-implemented method 100 assists the user in identifying the specific business based on the location of the user. For example, the user may indicate that she is attempting to conduct a transaction at a grocery store. The computer-implemented method 100 determines the location of the user based on the GPS in the mobile device and identifies the specific grocery store where the user is located. The computer-implemented method 100 may then provide the user with the specific grocery store's alias and allow the method to proceed accordingly.

In block 102, the computer-implemented method 100 establishes an alias for the user. In an embodiment, the computer-implemented method 100 establishes default aliases for users. For example, trademarked names may be established as default aliases for the businesses that own the trademarks. In another embodiment, the computer-implemented method 100 prompts the user to approve the default-generated alias. In some embodiments, however, the computer-implemented method 100 receives the alias from the user and establishes the alias after confirming that the alias meets pre-defined criteria. For example, the pre-defined criteria may include that a user cannot register another user's trademarked name as an alias or the pre-defined criteria may limit easily guessed or otherwise inappropriate aliases.

In some embodiments, the information provided by the user during registration of an alias may be verified to confirm that the user does have access to the mobile number, email address, social networking ID, trademarked name, or other alias provided. For example, as described in greater detail below, the financial institution (or other entity that maintains a database of aliases and associates them with financial institution accounts) may send a communication to the user using the alias and require that the user confirm access to the alias by responding to the notice in some way. For example, if the alias registered by the user is a mobile telephone number, the financial institution may send a text message to the mobile telephone number with a code and then require that the user enter the code into a mobile banking or online banking application to confirm that the mobile telephone number is associated with the user. In another example, if the alias is a trademarked name the financial institution may send a notice to the address of record for the trademark and require that the user confirm the alias request through proper channels.

In block 104, the alias is linked to one or more of the user's financial institution accounts. The financial institution accounts may include checking accounts, savings accounts, line of credit accounts, P2M-specific accounts, reward point accounts, gift card accounts, investment accounts, or other types of financial accounts. In some embodiments, the aliases and financial institution accounts are archived in a data repository maintained by the financial institution or some other entity that provides an alias registry service to the financial institution.

In some embodiments of the invention, the user may also have an option of opening a new P2M account with the financial institution that the user may use exclusively for making and/or receiving P2M payments. This financial entity P2M account may be like any other account hosted at the financial entity and money may be moved instantly into this account through the regular banking transfer process for moving money between a user's accounts. This account may be a type of checking account except that it may come with certain limitations, e.g., no checks, maximum balance limits, number of daily transactions or the like, and may be opened by users by providing much less information as compared to a regular checking account. The financial entity may, at a minimum, require users to provide certain information, such as name, address, date of birth, and social security number, in order to comply with Anti-Money Laundering (AML) regulations. Users of the financial entity may also have an option to set up P2M accounts (i.e., sub-accounts) for minors, other dependents, or related entities. Users are able to access these accounts just like any of their other accounts. In addition, users are able to set up a banking access ID for the minor that the minor may use to access only the specific minor P2M account set up for them. These P2M-specific accounts and sub-accounts are described in more detail in U.S. patent application Ser. No. 12/038,177 filed on Feb. 27, 2008 and entitled “Sub-Account Mechanism,” which application was assigned to, or subject to an obligation to assign to, the same assignee of the present application at the time of filing of the present application and at the time of conception of the inventions described herein, and is hereby incorporated by reference in its entirety.

In block 106, in some embodiments the computer-implemented method 100 determines that the user is attempting to conduct a transaction using the alias. In general, the user initiates a P2M payment using an alias by communicating an alias to the financial institution. In some embodiments, the alias is communicated to the business, which then communicates the alias to the financial institution. In further embodiments, the user is able to set preferences for default account(s) to be used for outgoing payments and default account(s) for incoming payments. In some embodiments of the invention, the user and/or financial institution places limits (e.g., maximums and/or minimums, etc.) on how much money can be sent or received over a specified period of time using P2M payment aliases, and such limits may be based on the sender, the business, whether the business is a user of the financial institution or a partner financial institution, account history, credit ratings, user status, whether the user has registered the alias, and/or any other relevant information. For example, a user may want to set a maximum of $1000 for P2M payments where an alias is used for the business as opposed to an account number.

In some embodiments of the invention, an alias may be associated with multiple financial institution accounts of the alias holder. In some such embodiments, the alias holder may be able to establish a default account when registering the alias or afterwards. Consequently, if a business has a default account for incoming payments, then the funds may be transferred instantly to that account(s). If the business has not set up a default account but the business does have multiple accounts associated with the alias, then the funds may be moved to a master settlement account and the business may see the payment as an incoming payment. The business may then be able to move the funds instantly to any of the business's other accounts.

In some embodiments, the alias may be a business name, for example a trademarked name, and payment may be made by the user providing the business name to the computer-implemented method. If the business is an existing financial institution user (or, in some embodiments, if the business is a user of a partner financial institution), then that business may be allowed to sign into their bank account, register the business name thereby associating the alias with a financial institution account for P2M payment purposes, and then receive funds similar to the process described above for the alias. If the business does not have an account eligible for receiving funds, then the business may be given the option to sign up for a financial institution account at the financial institution or return funds to the sender.

In some embodiments, the alias is a generic category and payment may be made by the user providing the category and a location. This operation may perform exactly as described above for a business name except that the location is used to identify the alias of the business using the alias data repository. Businesses are typically stationary and as such the location can be used to identify the alias of the business and provide it to the user. This embodiment has the additional advantage that the user does not need to know the exact alias of the business in advance in order to conduct a transaction with the business. The business may be contacted at the location to confirm the transaction or through other contact channels registered by the business at the time of registering the alias.

In some embodiments of the invention, payment may be made by providing a social networking ID, such as a unique ID associated with the business on a particular social networking Internet site. In such a situation, the process operates in the same way as described above for trademarked name and generic category except the social networking platform may be used to notify the business based on the social networking ID provided. For example, users may be able to conduct financial transaction using the Twitter™ name of a business as the business's alias.

Referring again to FIG. 1, users of the financial entity are able to make payments to businesses through any of a number of different methods. For example, payments may be made by a routing number/account number. Payments may also be made by providing an account number and an additional identifier, such as a zip code. If there is a match to an existing financial entity account then the funds are transferred instantly to that account. Otherwise, an error message may be generated.

In block 108, the computer-implemented method 100 accesses an alias database, or other type of data repository, to determine if the entered alias has been registered by the alias holder and is associated with a particular financial institution account. In an embodiment, users are able to change their aliases using a mobile device or web-accessible form. The ability to change the alias increases security compared to static account numbers. If there is no match in the alias data repository, then an error message is generated or, if possible, the alias may be used to contact the intended business and allow the business to register the alias and thereby associate the alias with a financial institution account.

In block 110, if the alias does have a match to a financial institution account then the computer-implemented method 100 conducts the transaction (e.g., payment is initiated to that business), as described in greater detail below. At any time, if outgoing payments or payment notifications are not received by the business, the payment may be cancelled.

In block 112, the computer-implemented method 100 confirms that the transaction was conducted according to the rules established by the user and/or financial institution. In an embodiment, a text message, email, online banking notice, mobile banking notice, or other type of message may be sent to the business. If there is other contact information found in the business's profile, the message notifying the business of the payment may be sent by the business's preferred contact method. In some embodiments, the business may be allowed to reject or re-route the payment. In some embodiments of the invention, the user is permitted to include a note to the business along with the payment, such as a note explaining the purpose of payment to the business.

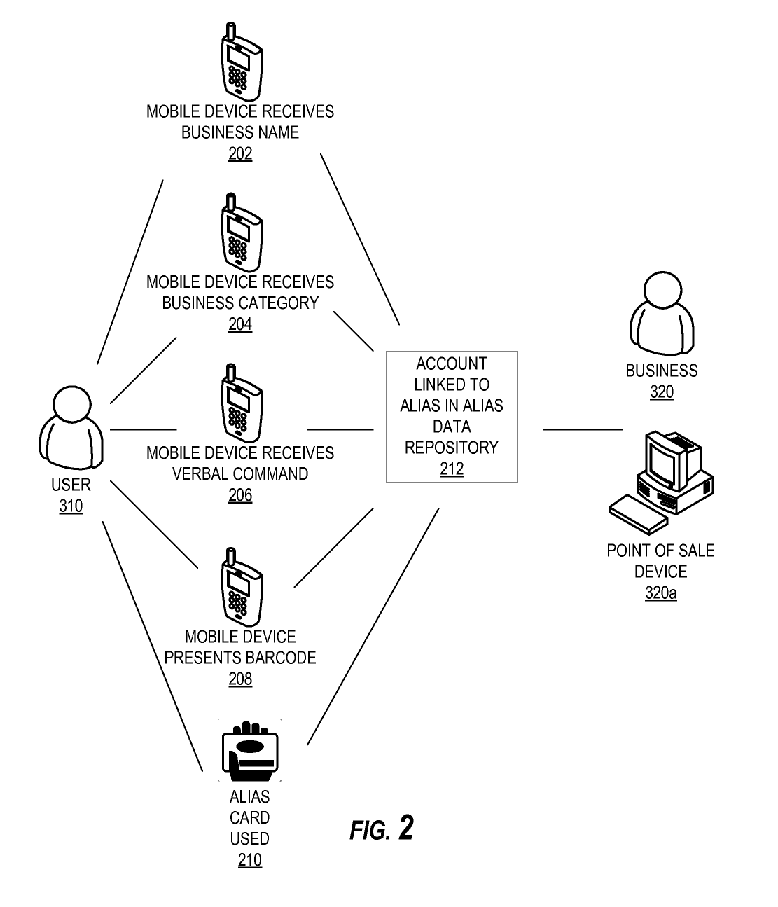

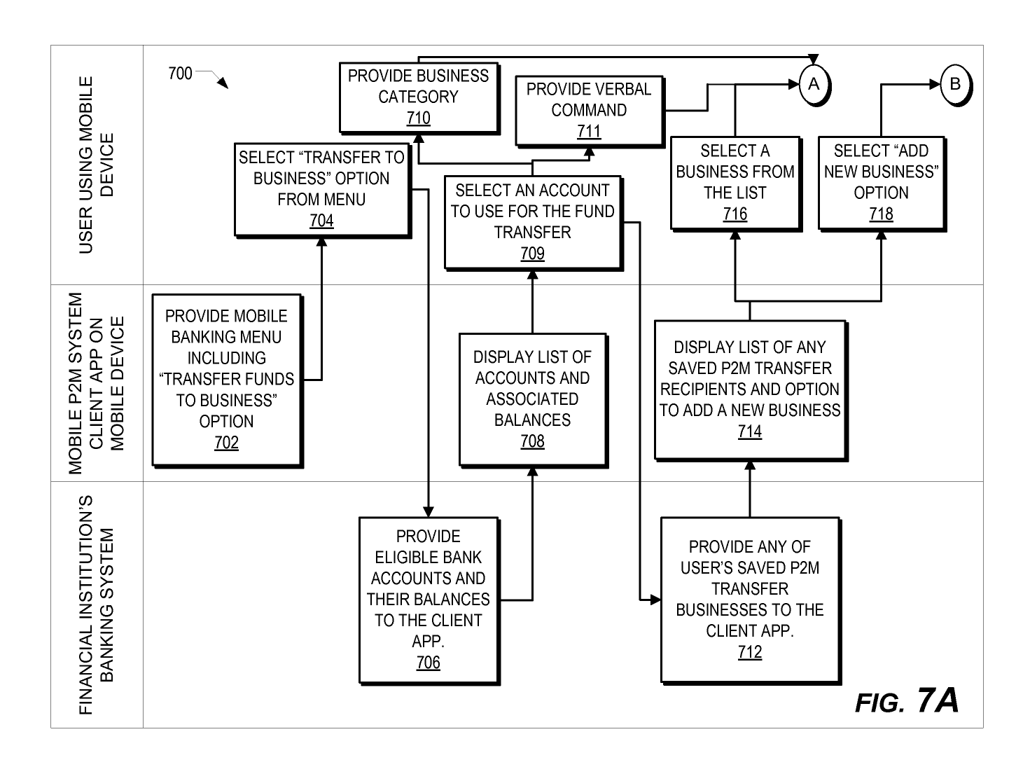

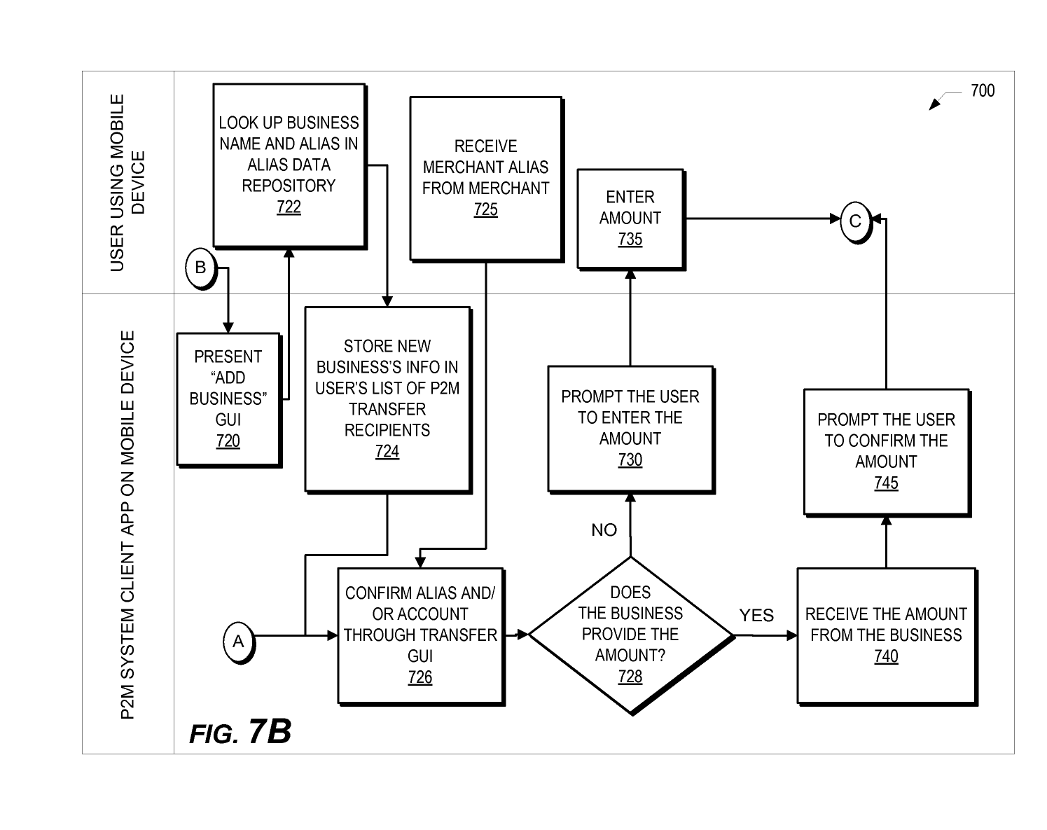

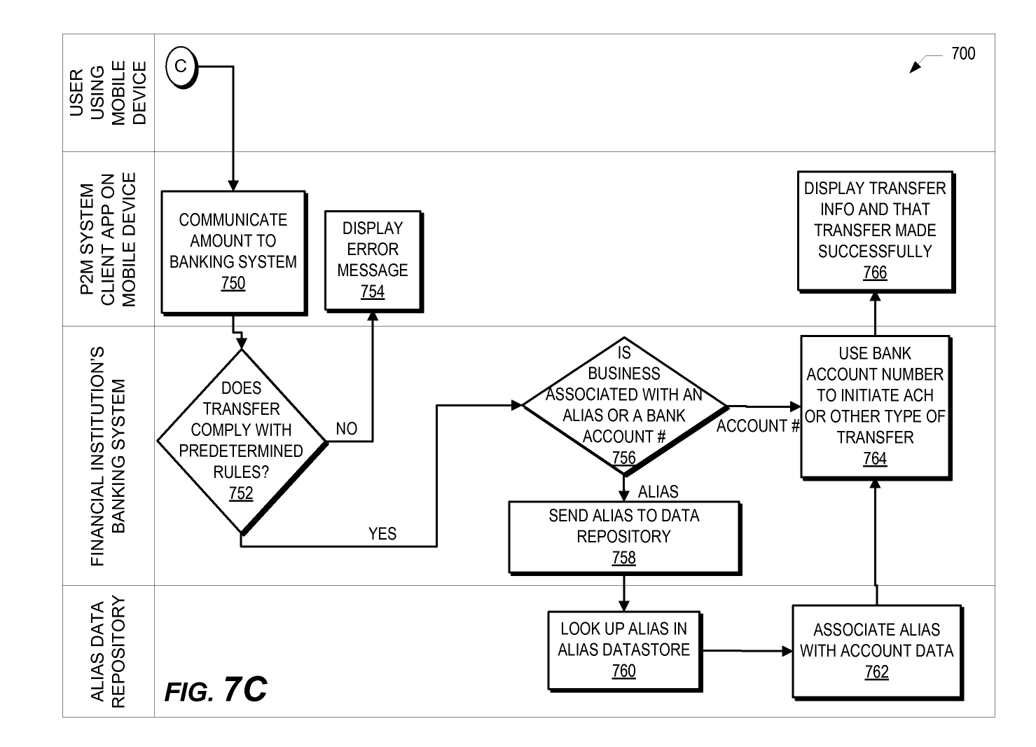

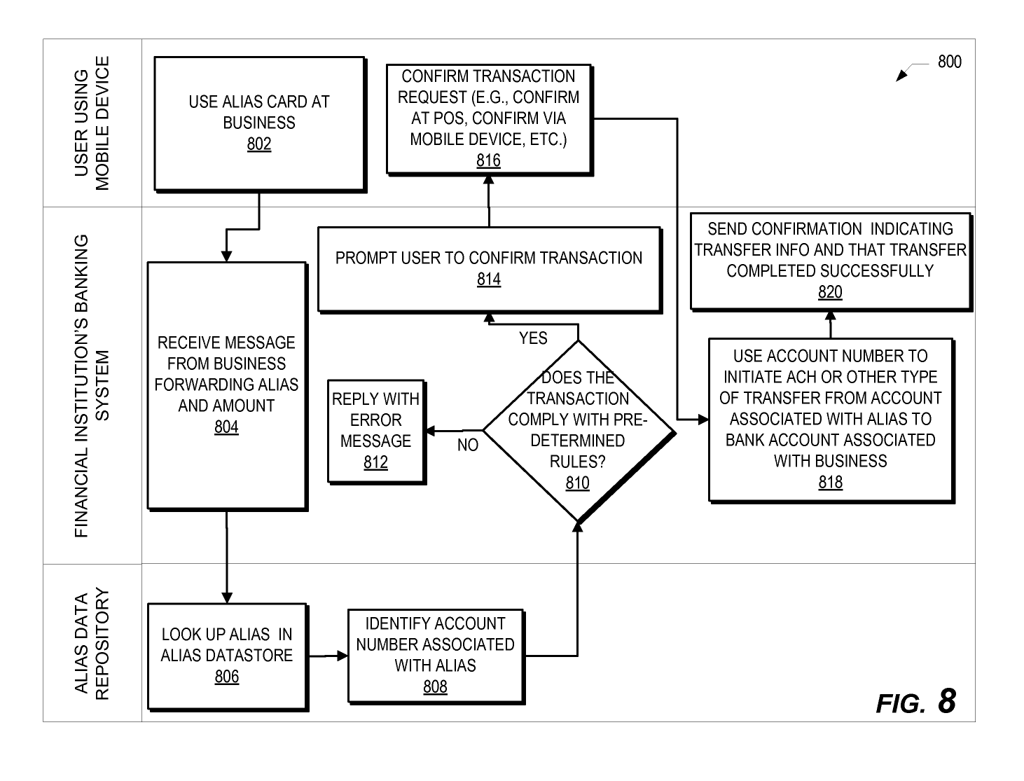

FIG. 2 is a block diagram illustrating the non-limiting examples by which a user may make P2M payments in accordance with various embodiments of the invention. As illustrated, in some embodiments of the invention, a user 310 who is signed up for the P2M payment service has the option to initiate P2M payments in a variety of ways. In the various embodiments, the user 310 initiates a P2M payment by entering a business name into a mobile device 202, entering a business category into a mobile device 204, providing a verbal command to a mobile device 206, presenting a barcode using a mobile device 208, or using an alias card 210 at a point of sale (POS) device 320a. Each of these embodiments will be discussed in greater detail in FIGS. 7-8. All of the embodiments, however, have in common that an alias from either the user 310 and/or the business 320 is provided and used when identifying 212 a financial institution account linked to the alias in an alias data repository. Other types of aliases, such as an email address, phone number, social networking ID, address, etc., are possible for both the user 310 and the business 320. In some embodiments of the invention, users can alternatively or additionally initiate payments by sending a text message 211 to the financial entity, the text message including the business's name, category, social networking ID, or other alias. Whether via a mobile banking handset application, alias card, short message service, or online banking website, a business 320 associated with the financial entity may receive funds at the business's financial institution account (e.g., DDA, savings, or credit account or P2M-specific account). A business 320 not associated with the financial entity may receive funds at the business's financial institution account at another partner financial institution if the account is registered and associated with the alias and/or the business may be prompted to register for the service and/or open an account with the financial institution in order to receive the payment from the sender.

It should be appreciated that embodiments of the invention described above permit an entity to send money to another entity even if the sending entity does not know any account information for the business and only knows a business name or social networking ID of the business. This can also result in better protection of personal account information. It should also be appreciated that some embodiments of the invention create a viral registration and/or account opening system that allows for users of a financial institution to send payments to businesses outside the financial entity using an alias. In such embodiments, the businesses are contacted using the alias and they are allowed to quickly open and/or register an account with the financial institution in order to receive the funds from the sender.

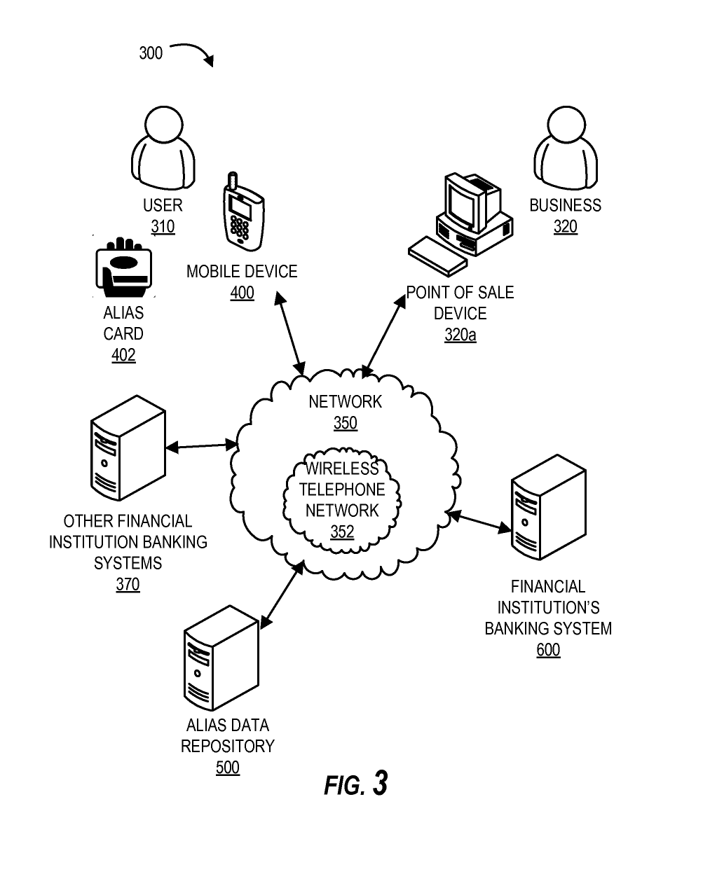

As described above, FIGS. 1 and 2 provide an overview of the alias-type P2M payment system and process of embodiments of the invention. FIGS. 3-8, described below, provide a more detailed description of some systems and methods of implementing embodiments the invention in a mobile banking environment. Specifically, embodiments of the invention described below disclose a user-friendly mobile banking interface and associated method that may be used by a financial institution to: (1) allow users to send P2M payments using an alias of the business; (2) allow users to register a user's aliases and then receive alias-type M2P payments from businesses; and (3) allow users to easily manage their P2M and M2P payments.

FIG. 3 provides a block diagram illustrating a P2M payment system and environment 300, in accordance with an embodiment of the invention. As illustrated in FIG. 3, the P2M payment environment 300 includes the user 310 and a business 320 where the user wants to send funds to the merchant. In another embodiment, the merchant wants to send funds to the user.

In some embodiments, the environment 300 includes a mobile device 400 for the user 310. As used herein, a “mobile device” 400 is any mobile device, such as a cellular telecommunications device (i.e., a cell phone or mobile phone), personal digital assistant (PDA), a mobile Internet accessing device, or other mobile device. In some embodiments, the mobile device 400 employs a processor and memory and can perform computing functions. In some embodiments, however, the mobile device 400 is a card 402 having a magnetic strip containing alias information. The card 402 will be discussed in greater detail with respect to FIG. 8 and will be referred to herein as an “alias card.”

The mobile device 400 is configured to communicate over a network 350 with a financial institution's banking system 600 and, in some cases, one or more other financial institution banking systems 370. The network 350 may include a local area network (LAN), a wide area network (WAN), and/or a global area network (GAN). The network 350 may provide for wireline, wireless, or a combination of wireline and wireless communication between devices in the network. In one embodiment, the network 350 includes the Internet. In one embodiment, the network 350 includes a wireless telephone network 352.

In general, the mobile device 400 is configured to connect with the network 350 to log the user 310 into the banking system 600. In some embodiments, the banking system 600 involves authentication of the user in order to access the user's account on the banking system 600. For example, the banking system 600 may be a system where the user 310 logs into his/her account such that the user 310 or other entity can access data that is associated with the user 310. For example, in one embodiment of the invention, the banking system 600 is a mobile banking system maintained by a financial institution. In such an embodiment, the user 310 can use the mobile device 400 to log into the mobile banking system to access the user's financial accounts. Logging into the banking system 600 generally requires that the user 310 authenticate his/her identity using a user name, a passcode, a cookie, a biometric identifier, a private key, a token, and/or another authentication mechanism that is provided by the user 310 to the banking system 600.

The financial institution's banking system 600 is in network communication with other devices, such as other financial institutions' banking systems 370, an alias data repository 500, and a point of sale (POS) device 320a that is configured to communicate with the network 350 to log the business 320 into the banking system 600. In an embodiment, the POS device 320a is a Near-Field Communication (NFC) enabled device or another type of device capable of communicating with the mobile device 400 of the user 310. In another embodiment, the POS device 320a may be network enabled and able to communicate with the user's device 400 over a wireless network or via Bluetooth™. In another embodiment, the POS device 320a communicates with the banking system 600, which in turn communicates the mobile device 400, and thus communication is enabled between all devices on the network 350 through relays.

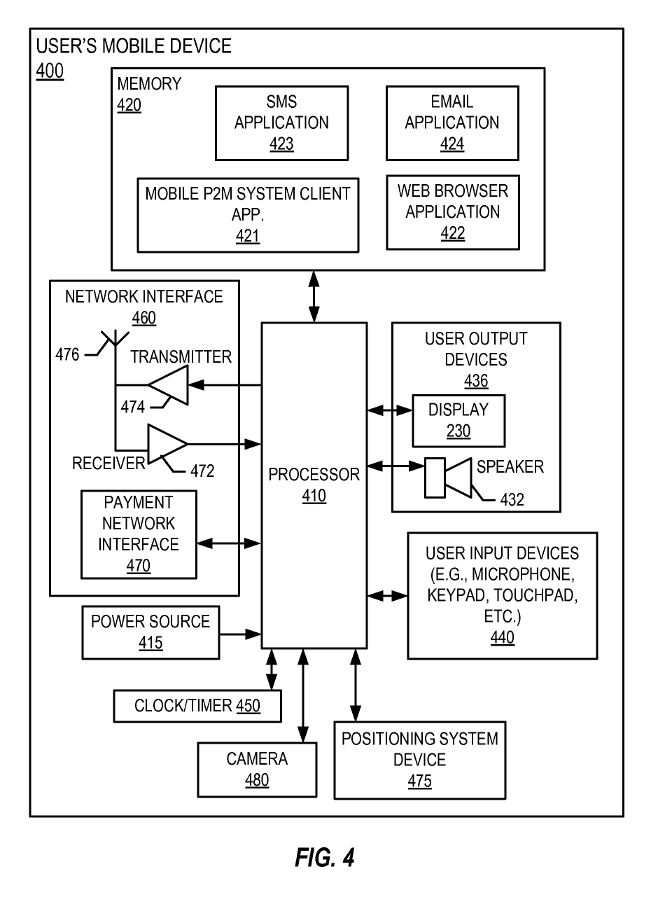

FIG. 4 provides a block diagram illustrating the mobile device 400 of FIG. 3 in more detail, in accordance with embodiments of the invention. In one embodiment of the invention, the mobile device 400 is a mobile telephone. However, it should be understood that a mobile telephone is merely illustrative of one type of mobile device 400 that may benefit from, employ, or otherwise be involved with embodiments of the present invention and, therefore, should not be taken to limit the scope of embodiments of the present invention. Other types of mobile devices 400 may include portable digital assistants (PDAs), pagers, mobile televisions, gaming devices, laptop computers, cameras, video recorders, audio/video player, radio, GPS devices, or any combination of the aforementioned.

The mobile device 400 generally includes a processor 410 communicably coupled to such devices as a memory 420, user output devices 436, user input devices 440, a network interface 460, a power source 415, a clock or other timer 450, a camera 480, and a positioning system device 475. In an embodiment, the network interface 460 includes a Near Field Communication device capable of communicating with other NFC enabled devices. The processor 410 and other processors described herein generally include circuitry for implementing communication and/or logic functions of the mobile device 400. For example, the processor 410 may include a digital signal processor device, a microprocessor device, and various analog to digital converters, digital to analog converters, and/or other support circuits. Control and signal processing functions of the mobile device 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the mobile device 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 350. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless telephone network 352. In this regard, the mobile device 400 may be configured to operate with one or more air interface standards, communication protocols, modulation types, and access types. By way of illustration, the mobile device 400 may be configured to operate in accordance with any of a number of first, second, third, and/or fourth-generation communication protocols and/or the like. For example, the mobile device 400 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 400 may also be configured to operate in accordance with non-cellular communication mechanisms, such as via a wireless local area network (WLAN), Bluetooth™ network, or other communication/data networks.

The network interface 460 may also include a payment network interface 470. The payment network interface 470 may include software, such as encryption software, and hardware, such as a modem, for communicating information to and/or from one or more devices on the network 350. For example, the mobile device 400 may be configured so that it can be used as a credit or debit card by, for example, wirelessly communicating account numbers or other authentication information to a terminal of the network 350.

As described above, the mobile device 400 has a user interface that is, like other user interfaces described herein, made up of user output devices 436 and/or user input devices 440. The user output devices 436 include a display 230 (e.g., a liquid crystal display or the like) and a speaker 432 or other audio device, which are operatively coupled to the processor 410. The user input devices 440, which allow the mobile device 400 to receive data from a user such as the user 310, may include any of a number of devices allowing the mobile device 400 to receive data from a user, such as a keypad, keyboard, touch-screen, touchpad, microphone, mouse, joystick, other pointer device, button, soft key, and/or other input device(s). The user interface may also include a camera 480, such as a digital camera.

The mobile device 400 may also include the positioning system device 475 that is configured to be used by a positioning system to determine a location of the mobile device 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate location of the mobile device 400. In other embodiments, the positioning system device 475 includes a proximity sensor or transmitter, such as an RFID tag, that can sense or be sensed by devices known to be located proximate a merchant or other location to determine that the consumer mobile device 400 is located proximate these known devices.

The mobile device 400 further includes a power source 415, such as a battery, for powering various circuits and other devices that are used to operate the mobile device 400. Embodiments of the mobile device 400 may also include a clock or other timer 450 configured to determine and, in some cases, communicate actual or relative time to the processor 410 or one or more other devices.

The mobile device 400 also includes the memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the mobile device 400 described herein. For example, the memory 420 may include such applications as a conventional web browser application 422 and/or a mobile P2M system client application 421. These applications also typically provide a graphical user interface (GUI) on the display 230 that allows the user 310 to communicate with the consumer mobile device 400, the banking system 600, and/or other devices or systems. In one embodiment of the invention, when the user 310 decides to enroll in the mobile banking program, the user 310 downloads or otherwise obtains the mobile banking system client application from the banking system 600 or from a distinct application server. In other embodiments of the invention, the user 310 interacts with the banking system 600 via the web browser application 422 in addition to, or instead of, the mobile P2M system client application 421.

The memory 420 can also store any of a number of pieces of information, and data, used by the mobile device 400 and the applications and devices that make up the mobile device 400 or are in communication with the mobile device 400 to implement the functions of the mobile device 400 and/or the other systems described herein. For example, the memory 420 may include such data as user authentication information, etc.

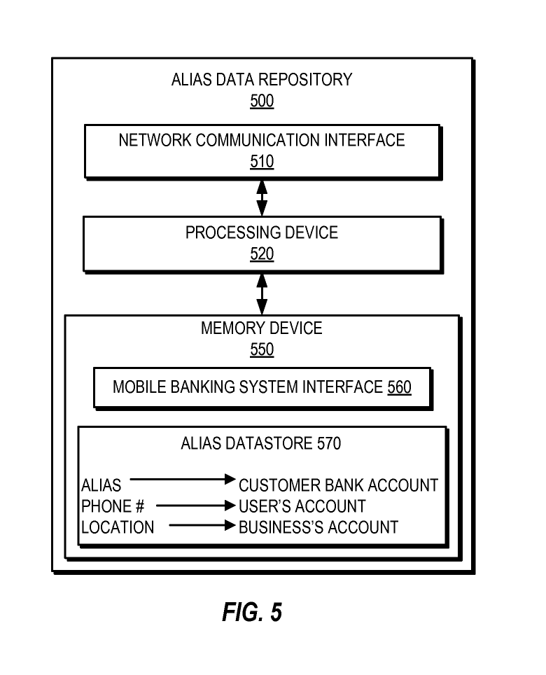

FIG. 5 provides a block diagram illustrating an alias data repository 500, in accordance with an embodiment of the invention. In one embodiment of the invention, the alias data repository 500 is operated by a second entity that is a different or separate entity from the first entity (e.g., the financial institution) that, in one embodiment of the invention, implements the banking system 600. In one embodiment, the alias data repository 500 could be part of the banking system 600. In another embodiment, the alias data repository 500 is a distinct entity from the banking system 600. As illustrated in FIG. 5, the alias data repository 500 generally includes, but is not limited to, a network communication interface 510, a processing device 520, and a memory device 550. The processing device 520 is operatively coupled to the network communication interface 510 and the memory device 550. In one embodiment of the alias data repository 500, the memory device 550 stores, but is not limited to, a mobile banking system interface 560 and an alias data store 570. The alias data store 570 stores data including, but not limited to, an alias for the user's financial institution account, an alias for the business's financial institution account, rules associated with transactions conducted through the P2M system, locations of users and/or businesses, and contact information for the users and/or businesses registered with the P2M system. In one embodiment of the invention, both the mobile banking system interface 560 and the alias data store 570 may associate with applications having computer-executable program code that instructs the processing device 520 to operate the network communication interface 510 to perform certain communication functions involving the alias data store 570 described herein. In one embodiment, the computer-executable program code of an application associated with the alias data store 570 may also instruct the processing device 520 to perform certain logic, data processing, and data storing functions of the application associated with the alias data store 570 described herein.

The network communication interface 510 is a communication interface having one or more communication devices configured to communicate with one or more other devices on the network 350. The processing device 520 is configured to use the network communication interface 510 to receive information from and/or provide information and commands to a mobile device 400, other financial institution banking systems 370, the alias data repository 500, the banking system 600, and/or other devices via the network 350. In some embodiments, the processing device 520 also uses the network communication interface 510 to access other devices on the network 350, such as one or more web servers of one or more third-party data providers. In some embodiments, one or more of the devices described herein may be operated by a second entity so that the third-party controls the various functions involving the alias data repository 500. For example, in one embodiment of the invention, although the banking system 600 is operated by a first entity (e.g., a financial institution), a second entity operates the alias data repository 500 that stores the alias details for the user's financial institution accounts and other information about users.

As described above, the processing device 520 is configured to use the network communication interface 510 to gather data from the various data sources. The processing device 520 stores the data that it receives in the memory device 550. In this regard, in one embodiment of the invention, the memory device 550 includes datastores that include, for example: (1) aliases for user financial institution account numbers and routing information, (2) information about sending and receiving users' mobile device numbers, email addresses, customer support phone numbers, or other contact information, which may have been received from the banking system 600; (3) a list of user IDs or authentication data received from the banking system 600; and/or (4) user credentials (e.g., a user ID) received from the user's mobile device 400 or received from the banking system 600 in response to the user accessing the banking system 600.

In some embodiments of the invention, the alias data repository 500 is configured to be controlled and managed by one or more third-party data providers (not shown in FIG. 3) over the network 350. In other embodiments, the alias data repository 500 is configured to be controlled and managed over the network 350 by the same entity that maintains the financial institution's banking system. In other embodiments, the alias data repository 500 is configured to be controlled and managed over the network 350 by the financial institution implementing the mobile payment system of the present invention. In still other embodiments, the alias data repository 500 is a part of the banking system 600.

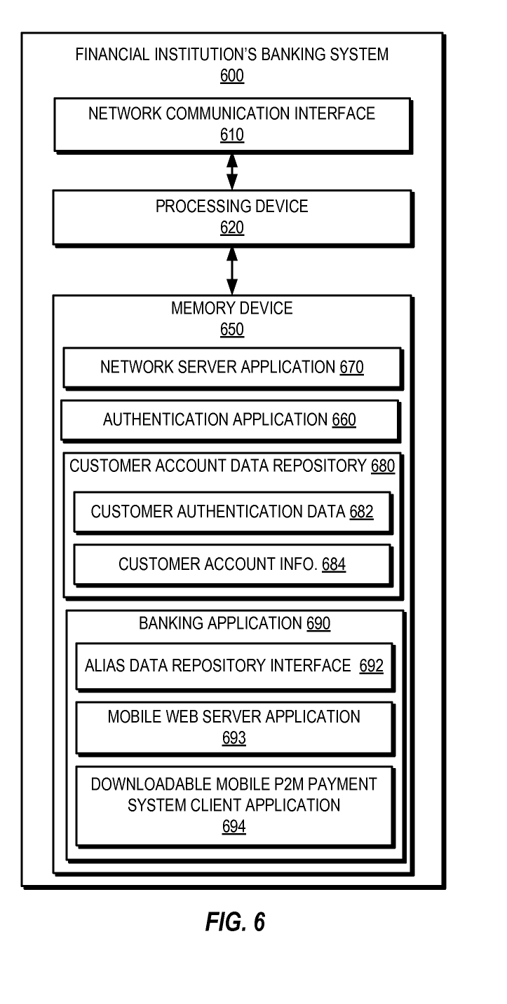

FIG. 6 provides a block diagram illustrating the banking system 600 in greater detail, in accordance with embodiments of the invention. As illustrated in FIG. 6, in one embodiment of the invention, the banking system 600 includes a processing device 620 operatively coupled to a network communication interface 610 and a memory device 650. In certain embodiments, the banking system 600 is operated by a first entity, such as a financial institution, while in other embodiments the banking system 600 is operated by an entity other than a financial institution.

It should be understood that the memory device 650 may include one or more databases or other data structures/repositories. The memory device 650 also includes computer-executable program code that instructs the processing device 620 to operate the network communication interface 610 to perform certain communication functions of the banking system 600 described herein. For example, in one embodiment of the banking system 600, the memory device 650 includes, but is not limited to, a network server application 670, an authentication application 660, a user account data repository 680, which includes user account data repository 680 and user account information 684, a banking application 690, which includes an alias data repository interface 692, and other computer-executable instructions or other data. The computer-executable program code of the network server application 670, the authentication application 660, or the banking application 690 may instruct the processing device 620 to perform certain logic, data-processing, and data-storing functions of the banking system 600 described herein, as well as communication functions of the banking system 600.

In one embodiment, the user account data repository 680 includes user authentication data 682 and user account information 684. The network server application 670, the authentication application 660, and the banking application 690 are configured to implement user account information 684, the user authentication data 682, and the alias data repository interface 692 when authenticating the user 101 to the banking system 600. The user account information 684, the user authentication data 682, and the alias data repository interface 692 are discussed in more detail in a later section.

As used herein, a “communication interface” generally includes a modem, server, transceiver, and/or other device for communicating with other devices on a network, and/or a user interface for communicating with one or more users. Referring again to FIG. 6, the network communication interface 610 is a communication interface having one or more communication devices configured to communicate with one or more other devices on the network 350, such as the mobile device 400, the banking system 600, the other financial institution banking systems 370, and the alias data repository 500. The processing device 620 is configured to use the network communication interface 610 to transmit and/or receive data and/or commands to and/or from the other devices connected to the network 350.

FIGS. 7A-7C provide flow charts illustrating a process 700 for sending P2M payments to a business using an alias of the business, in accordance with embodiments of the invention. FIGS. 7A-7C illustrate the flow chart in terms of “swim lanes” associated with entities which may perform the operations in each respective swim lane. The entities illustrated in the exemplary Figures are a financial institution's banking system, a user using a mobile device, an alias data repository, and a business. However, it should be noted that other entities could also be involved and some embodiments of the invention may not be limited to the entities illustrated in FIGS. 7A-7C. Additionally, it should be understood that, in other embodiments of the invention, the entities need not be required to perform the actions illustrated in each respective swim lane. For example, some of the process steps described herein may be performed by the first entity (or other entities) even though the element may be illustrated as in the swim lane of the second entity. Similarly, in some embodiments, some of the process steps may be performed by the second entity (or other entities) even though the element may be illustrated as in the swim lane of the first entity.

In block 702 of FIG. 7A, in some embodiments the P2M system client application 694 provides a banking menu including an option to transfer funds to a business. In some embodiments, the banking system 600 includes an authentication process whereby the user authenticates the user's identity and grants access to the P2M system client application 694. For example, the user may enter a password or use biometric security features to gain access to the application. In an embodiment, the mobile P2M system client application 694 displays a menu page on which the user can navigate to an accounts function, a bill-paying function, a transfer funds function, or a location function. Further, in some embodiments the P2M payment system client application 694 indicates to the user that the user is in a secure area of the banking system 600. In still further embodiments, the bank menu page has a text area where error messages are displayed and allows users to sign out from their accounts on any mobile webpage by providing an appropriate hyperlink or button.

If the user selects the equivalent of the “transfer to business” option in the menu, as depicted in block 704, the user will begin the process of transferring funds to a business using the P2M system and process. In other embodiments, options to transfer funds to an individual or to edit the P2M system are also available on the menu.

In block 706, in some embodiments the banking system 600 provides eligible financial institution accounts to the P2M system client application 694. In an embodiment, the banking system 600 also provides balances to the P2M system client application 694. In further embodiments, however, only a single account is available to the user for P2M transactions. In this embodiment, the single account may be an account specifically designed for P2M transactions or it may be an account designated by the user from among the user's standard accounts (e.g., checking, credit card, etc.). If only a single account is available to the user for P2M transactions, then the step in block 706 may be skipped. Further, if the user sets up rules relating to accounts to use for specific types of transactions, then the user may not need to select an account. For example, the user may set up a rule that P2M transfer of less than $20 should be conducted through a checking account and that any P2M transfer of greater than or equal to $20 should be conducted through a credit card account.

In block 708, the P2M system client application 694 displays a list of eligible financial institution accounts that can participate in the P2M transfer, in some embodiments. In further embodiments, the P2M system client application 694 may also indicate to the user the balances of the accounts or that the account balances may reflect transactions that have not yet been posted to the user's account. If the amount is provided by the business, as will be discussed later, then the P2M system client application 694 may also provide the projected balance should the transfer occur. For example, if an account has a balance of $1000 and the user is contemplating purchasing an item costing $100, the P2M system client application 694 may present both the current balance and the projected balance of $900 ($1000-$100) should the user complete the transaction using the P2M system and method.

In block 709, in some embodiments the user 310 selects an account to use for the fund transfer. As discussed previously, if only a single account is available or if rules pre-determine the account that will be used for the transfer then this step may not be completed.

After the account is determined, the user 310 provides the business's alias to the system and method. The user 310 is able to provide the business's alias in a variety of ways. For example, the user can select the name of the business from a menu provided by the application. In another embodiment, the user provides a category that the business is within and the system determines the alias from the category and the user's location. In some embodiments, the banking system 600 determines the business's alias based on the user's location. In a still further embodiment, the user speaks the name of the business into a microphone on the mobile device 400 and the computer-implemented method determines the alias after converting the audible command into a command that the computer-implemented method recognizes. In a still further embodiment, the business provides the business's alias based on a Near Field Communication (NFC) device associated with the point of sale 320a. Each of these embodiments will be discussed in blocks 710-726.

In block 710, in some embodiments the user 310 provides a category for the business. For example, the user may be visiting a gas station, a grocery store, or a restaurant. Common categories may be displayed in a list on the mobile device 400, and other categories may be searchable. As should be understood, a large variety of categories are available to characterize businesses. In an embodiment, the user also provides the current location. In an exemplary embodiment, however, the P2M system client application 694 determines the user's location using the positioning system device 475. The banking system 600 receives the business category and user's position and determines the alias of the business the user is visiting based on this information. In an embodiment, the information regarding categories and location is included in the alias data repository 500. In another embodiment, the category and location data is present in other financial institution data, such as account set-up data, or present in publicly available data, such as map data. The category and location of the business can be used to determine the name of the business for use in finding the business's account number in the alias data repository 500.

In a further embodiment, the mobile device 400 and banking system 600 is able to determine the business's alias based on the location of the user 310. For example, the positioning system device 475 may provide the user's location to the banking system 600. In response, the banking system determines the business 320 where the user 310 is located and identifies the business's alias. In an embodiment, the business name or business location is present in the alias data repository 500 and associated with the alias. It should be understood that the mobile device 400 and/or banking system 600 may determine the user's location in a different manner than by using the positioning system device 475. For example, the mobile device 400 may determine the user's location based on triangulating between cell phone towers, based on input from the user, or based on information provided by local networks (e.g., wireless network or information pushed from NFC node).

In block 711, in some embodiments the user provides verbal commands that include the business alias. In some embodiments, the mobile device 400 includes the microphone and receives verbal commands from the user. For example, the user may speak into the microphone on the mobile device and say “Pay Storename.” In some embodiments, the P2M system client application 694 includes speech recognition software that analyzes the audible command and converts the verbal command into a command that the banking system 600 recognizes. For example, the banking system 600 may identify the word “Storename” using speech recognition software and search the alias data repository 500 for the account number based on the alias “Storename.” In a further embodiment, the verbal commands may include an amount or the user's alias. For example, the user could speak into the microphone on the mobile device and say “Username pays Storename Fifty Dollars.” The speech recognition software evaluates the verbal command and identifies the user's alias, i.e., “username,” the business's alias, i.e., “storename,” the action, i.e., “pay,” and the amount, i.e., $50. The banking system 600 would then have sufficient information to conduct the transaction. In some embodiments, the user does not need to transfer the user's alias to the business because the banking system 600 is aware of the user's identity and able to identify the user's accounts. In other embodiments, however, the user transfers the user's alias to the business as well, as will be discussed in greater detail in FIG. 8.

In some embodiments, the banking system 600 receives the business's alias from the business. For example, the business point-of-sale device 320a may be associated with an NFC device that is configured to push the business's alias to a receiver, such as a network interface device on the mobile device 400. The NFC device may be part of the point-of-sale device 320a or located proximate to the point-of-sale device 320a such that a user receiving a signal from the device receives the business's alias. This will be discussed in greater detail in block 725.

In block 712, in some embodiments the banking system 600 provides any of the user's saved P2M businesses to the P2M system client application 694. By providing the saved P2M businesses to the application, the banking system 600 is increasing the speed with which the user is able to conduct the transaction. The banking system 600 can filter the saved businesses by location, frequency with which the user visits the businesses, or any other characteristic. For example, if the user visits the same coffee shop every morning the banking system 600 can provide the coffee shop alias in the list of businesses between 7 am and 9 am.

In some embodiments, when the P2M system client application 694 receives the list of saved businesses, the application displays the list to the user. In an embodiment, the list is displayed in a manner that is convenient and intuitive for the user to select a business. For example, the list may be presented on a touchscreen so that the user may simply tap the business name and select the business by alias. Rather than having to remember the business's official name or account number, the user is able to simply identify the business by alias and proceed with conducting the transaction.

In block 716, the user 310 selects a business from the list to participate in the P2M transfer. In some embodiments, when the user selects the business the user is taken to a page displaying details of the business so that the user is able to confirm that the business is the intended transfer recipient. When the user selects the business, the P2M system client application 694 presents a transfer GUI to the user, which will be discussed in greater detail in block 726.

Alternatively, in some embodiments the user does not find the business in the list or does not want to search the list and instead the process moves to block 718 where the user selects the option to add a new business. The new business can be a large or small business. In some embodiments, new businesses are limited to businesses that already have aliases but in other embodiments the user can add new businesses that do not yet have aliases. When the user attempts to add a new business that does not have an alias, the business may be contacted by the financial institution and provided the opportunity to enroll in the alias program. In an embodiment, records are kept of how many users attempt to pay a business using an alias and this information is presented to the business each time a new user attempts to pay using the alias. This reminder that individuals desire the convenience and security of aliases may encourage businesses to register aliases with the system.

In block 720 of FIG. 7B, the P2M system client application 694 presents a GUI to the user to add the new business. In some embodiments, the P2M system client application 694 presents an input field to enter the business's name. In one embodiment, the alias can be, but is not limited to, the business's trademarked name or slogan. In another embodiment, the application suggests the name of the business based on the user's location. The location may be determined by the positioning system device or by the user entering the location. In an embodiment, the GUI is configured to automatically complete the business name as the user enters the name. In another embodiment, the user's purchase history is evaluated to assist the application in identifying business. Users often revisit the same businesses and if the user paid the business using a standard process previously, the application may be able to determine the business name, alias, or account number from the previous transaction.

In some embodiments, the user looks up the business name and alias in the alias data repository, as depicted in block 722. In an embodiment, the banking system 600 assists the user by identifying the location of the user, as previously discussed, and suggesting a possible business that the user is visiting. In other embodiments, however, the location of the user may not be available to the user. For example, the mobile device may not have a positioning system, the positioning system may not be accurate, or the business may be mobile. In some embodiments, therefore, the user selects the business from a list of businesses presented to the user. The list can be organized by categories, alphabetically, by most recent location, or in any other manner desired by the user or financial institution.

In some embodiments, the P2M system client application 694 locally stores the new business's information in the user's list of P2M transfer recipients, as depicted in block 724. By storing the new business's information in the user's list, the system and method makes it even more convenient for the user to conduct transaction at businesses that the user has already visited. Rather than having to identify the business in the database or by location, the user is able to select the business in a suggested businesses list.

In block 725, the P2M system client application 694 may also receive the business's alias directly from the business instead of being generated at least in part by the user. In an embodiment, the business includes a transponder that is able to communicate with the P2M system client application. For example, the business may wireless sync with the user's mobile device and transfer the business's alias to the P2M system client application 694. In another embodiment, an email, twitter message, social networking message, or text message may be generated by the business and transfer the business's alias to the user. In some embodiments, a Near Field Communication device associated with the business can transfer the business's alias directly to the user's NFC-enabled mobile device. The user is able to accept this alias automatically or based on user input, as shown in block 726.

Turning now to block 726, the mobile P2M system client application 694 presents a transfer GUI showing the account and the selected business. In an embodiment, the business 320 provides the amount to the banking system 600, as depicted in block 740. In another embodiment, the mobile P2M system client application 694 prompts the user to enter the amount, as depicted in block 730. In some embodiments, the GUI also presents disclosure text regarding any possible fees that will be incurred by the user for making this transfer. The GUI also displays a submit button for submitting the transfer and a cancel button for cancelling the transfer and returning to the menu page.

In another embodiment, if the user receives the alias from the business the user is able to confirm the alias before proceeding with the transaction. In an embodiment, the user confirms and accepts by entering a PIN or indicating confirmation in another manner. For example, the alias name received from the business may be displayed on the touchscreen and the user accepts the name by tapping the touchscreen. The user may also accept or reject the alias in other ways, such as by voice command, movement of the mobile device, etc. In one example, the user rejects a transferred alias by shaking the mobile device and clearing the alias from the screen.

In block 730, once the P2M system client has an alias that the user accepts, either through user entry or receiving from the business, the P2M system client application 694 determines the amount of the transaction. In one embodiment, the P2M system client application 694 prompts the user to enter the amount if the business does not provide the amount. In some embodiments, the user inputs the amount of money that the user intends to transfer to the business. For example, the user may enter the amount using a keypad on a mobile device or by inputting an amount using a touchpad. In one embodiment, the user intends to transfer an amount to the business multiple times, such as when purchasing a product on an installment plan. In this embodiment, the user is able to select an appropriate frequency option from a drop-down list which lists several frequency options, such as a one-time, immediate transfer, a one-time future transfer, a periodic transfer over a preconfigured cycle or the like.

In block 740, in some embodiments the P2M system client application 694 receives the amount from the business 320. In an embodiment, the business 320 transfers the amount over the network 350. For example, the business may include a Near Field Communication device at the point of sale. In another example, the business may include a wireless network, a Bluetooth™ network, or other type of network capable of pushing the transaction amount to the banking system 600 or mobile device 400. In further embodiments, the business 320 provides the transaction amount including the purchase price and taxes but does not include any fees associated with using the alias. As will be discussed, when the mobile device 400 receives the amount from the business, in some embodiments the user accepts the amount and authenticates the user's identity by entry of a passcode. Then, the user's acceptance is transmitted to the business and the transaction is completed. The user's acceptance may be transferred over the same network (e.g., NFC, Bluetooth™, wireless network, etc.) or over a different network (e.g., a bank's transaction processing network, etc.).

In block 750 of FIG. 7C, once the amount is provided, either from the user in block 735 or the business in block 740 and confirmed by the user in block 745, the P2M system client application 694 communicates the amount to the banking system 600. In an embodiment, the amount is communicated. In another embodiment, the amount and any taxes/fees are communicated to the banking system 600. In still further embodiments, additional information is communicated to the banking system 600, such as demographic data associated with the transaction, customer history data, or other data that may be used to customize and/or personalize the system and method and increase customer satisfaction.

In some embodiments, the banking system 600 determines whether the transfer complies with pre-determined rules. In an embodiment, the pre-determined rules are established by the user. In another embodiment, the pre-determined rules are established by the business or the financial institution. All or any combination of user, business, and financial institution may establish rules governing P2M transfers. For example, a P2M transfer may be limited to amounts less than a pre-determined amount, such as $1000. If a user attempts to transfer more than $1000 using the P2M system and method, the user will receive an error message on the mobile device, as depicted in block 754. Using the P2M service is dependent on several factors that affect this limit including, but not limited to, the user's identity, the business's identity, the length and nature of the user's relationship with the financial institution, the length and nature of the business's relationship with the financial institution, the amount of funds that the user has deposited at the financial institution, the user's financial institution status, etc. In one embodiment, the maximum amount that can be transferred using the P2M transfer method is dynamically determined at the time the transfer is set-up by a supporting application that works in conjunction with or is embedded within the P2M system client application 694. Other types of rules that can be established for P2M transfers include rules regulating the frequency of P2M transfers, rules regulating the types of recipients (e.g., specific businesses may not receive P2M transfers or specific categories may not receive P2M transfers, etc.), rules regulating the timing of P2M transfers (e.g., no transfers on weekends or no transfers after 11 pm, etc.), rules regulating the location of P2M transfers (e.g., use of the positioning system device to determine the user's location and then allowing or preventing transfers based on the location, etc.). It should be understood that other types of rules or combinations of rules are possible.

If the banking system determines that the transfer complies with the pre-determined rules, then the process moves to block 756. Here, the banking system 600 determines whether the business selected by the user in block 726 is associated with an alias or a financial institution account number. The banking system 600 determines whether the business is associated with an alias or account number by evaluating the input or stored data associated with the business. Account numbers are identifiable by a consistent length of numbers and/or letters, as appropriate for different types of accounts. Aliases, however, may vary widely in length and form. If the banking system 600 is unable to determine whether the input is an alias or account number, in some embodiments the banking system 600 queries the user to clarify (not shown).

If the selected business is associated with a financial institution account, the banking system 600 uses the financial institution account number to initiate an Automated Clearing House (ACH) transfer or other type of transfer, as depicted in block 764. The ACH transfer or other type of transfer completes through standard channels because the account numbers of both the user and the business are known.

If, however, the business is associated with an alias then the process moves to block 758 where the banking system 600 sends the alias to an alias data repository 500. The banking system 600 may push the alias to the alias data repository 500 over the network 350. In an embodiment, the banking system 600 encrypts the alias before sending it to the alias data repository 500.

In the alias data repository 500, the alias is looked up in an alias datastore. In an embodiment, the alias datastore is a database that includes aliases and associated information such as account numbers, contact information, location, and other information. In some embodiments, the alias is then associated with a financial institution account. Then the process moves to block 762 where the alias data repository 500 associates the alias with a financial institution account. Other information may be added to the alias data repository, such as customer purchase history, or received from the alias data repository, such as customer loyalty information for the business.

When the alias is associated with the financial institution account number, the banking system 600 uses the financial institution account number to initiate an ACH transfer or other type of transfer, as depicted in block 764. In some embodiments, the transfer occurs using standard channels because the user account number, business account number, and amount are known.

Subsequently, the process moves to block 766 where the P2M system client application 694 provides notification to the user 310 and/or business 320 that a transfer or a notice of transfer request to the business has been initiated and displays the information regarding the transfer. In some embodiments, the mobile device provides a confirmation page that displays the transfer-from account, the transfer-to account or business alias, the amount transferred, the fee incurred by the user for making this transfer, the total cost of the transfer, and the date on which the transfer was executed. In further embodiments, the confirmation page also displays a confirmation number associated with the transfer.

In one embodiment of the invention, both the sender and the business have financial institution accounts registered for P2M transfer via alias. In another embodiment of the invention, the sender has a financial institution account registered for P2M transfer via alias, but the business does not have a financial institution account registered for P2M transfer via alias. In another embodiment of the invention, the business has a financial institution account registered for P2M transfer via alias, but the sender does not have a financial institution account registered for P2M transfer via alias.

FIG. 8 provides a flow chart illustrating a process 800 for sending P2M payments to a business by providing the user's alias, in accordance with an embodiment of the invention. In an exemplary embodiment depicted in FIG. 8, the user provides the user's alias using an alias card. In another embodiment, the user provides the user's alias by presenting a barcode on the mobile device 400 using the P2M system client application 694. The embodiment where the user presents a barcode will be discussed after the embodiment where the user uses an alias card at the POS device. Both embodiments, however, may incorporate features of the other.

FIG. 8 illustrates the flow chart in terms of “swim lanes” associated with entities which may perform the operations in each respective swim lane. The entities illustrated in the exemplary Figure are a financial institution's banking system 600, a user (sender) 310 using an alias card 402, and an alias data repository 500. A business (not shown) is associated with the actions performed by the user, the banking system 600, and the alias data repository; however, in some embodiments the business completes the transactions in a standard manner and hence those actions are not depicted. It should be noted that other entities could also be involved and some embodiments of the invention may not be limited to the entities illustrated in FIG. 8. Additionally, it should be understood that, in other embodiments of the invention, the entities need not be required to perform the actions illustrated in each respective swim lane. For example, some of the process steps described herein may be performed by the first entity (or other entities) even though the element may be illustrated as in the swim lane of the second entity. Similarly, in some embodiments, some of the process steps may be performed by the second entity (or other entities) even though the element may be illustrated as in the swim lane of the first entity.

All features that are described above as being part of the P2M payment process and interface are also part of the alias card P2M payment process and service. In one embodiment of the invention, the alias card P2M payment send process and interface is a feature provided in the P2M payment send process and interface. In another embodiment of the invention, the alias card P2M payment send process and interface is distinct from the P2M payment send process and interface. This alias card P2M transfer feature is particularly useful for users who do not carry mobile devices or who carry mobile devices that do not have computing resources and cannot access the Internet.

In block 802, the user 310 (sender) uses the alias card at a business 320. In an embodiment, the user 310 swipes the alias card in a similar manner as the user would swipe a credit or debit card. Rather than transferring the user's account number, however, the alias card transfers the user's alias stored in the magnetic strip. In another embodiment, the user 310 presents the alias card at the POS and an employee of the business enters numbers printed on the alias card or scans a bar code on the alias card to gain access to the alias stored therein.

In some embodiments (now shown), the user is able to change the alias stored on the alias card by presenting the alias card at a bank or by using an ATM. For example, the user may insert the alias card into the ATM and then proceed to change the alias stored on the card by completing an authentication and change process at the ATM. In another embodiment, a device may be provided that allows the user to change the alias stored on the alias card. The ability to change the alias stored on the alias card provides additional security to the user. Being able to change the alias allows the user to maintain the same card even if the alias previously stored therein becomes known. The user would merely change the old alias to a new one and have the heightened level of security with the convenience of using a swipe card. Additionally, if the alias card is lost the user can maintain security by logging into an online system and unregistering the alias on the alias card.

The process then moves to block 804 where the banking system 600 and computer-implemented method receives a communication from the business 320. The communication forwards the alias and the transaction amount to the banking system 600. For example, the business 320 may scan a product for purchase and send the total cost of the product including taxes to the banking system. In some embodiments, the user 310 provides the transaction amount to the banking system 600. The banking system 600 and/or business 320 then determines the total transaction amount including taxes and any fees. In an embodiment, the banking system 600 receives the alias and the transaction amount over the network 350. In some embodiments, the alias and amount are encrypted.

In block 806, the banking system 600 and computer-implemented method looks up the alias in the alias data repository 500. If the alias data repository 500 determines that the alias is not associated with a financial institution account, the banking system 600 replies to the business and/or user with an error message that the transaction cannot be completed. In one embodiment, the error message is sent over standard transaction processing channels or via text message, however, in other embodiments, the error message can be sent by any form of communication such as email, placing a phone call to the user, mail, etc.

If, however, the banking system 600 and computer-implemented method determines that the alias is associated with a financial institution account, then the account number associated with the alias is identified, as depicted in block 808. If more than one account number is associated with the alias, the banking system 600 and computer-implemented method will review whether any rules apply for which account number to use for the alias, as discussed previously. In an embodiment (now shown) the banking system 600 and computer-implemented method queries the user to determine which account to use. If only a single account is associated with the alias then that account number is identified in the alias data repository 500 and provided to the banking system 600.

In block 810, in some embodiments the banking system 600 and computer-implemented method determines whether the transaction complies with pre-determined rules. For example, the banking system 600 may determine whether the transfer amount is above the maximum that may be transferred in this transaction. If the banking system 600 determines that the transfer amount is above the maximum that may be transferred in this transaction, then the banking system 600 replies to the user 310 with an error message that the transaction cannot be completed (see block 812). In one embodiment, the error message is sent via text message, however, in other embodiments, it can be sent by any form of communication such as email, placing a phone call to the user, snail mail etc. Other types of pre-determined rules are possible. For example, the user 310 may set a maximum number of P2M transfers per day, per user, or per business. In another example, the user 310 may allow P2M transfers for specific categories of purchases (e.g., gas stations, etc.) or until the balance on an account reaches a pre-determined level (e.g., below $200, etc.). Other types of pre-determined rules are possible and the aforementioned examples are not intended to be limiting. Further, the pre-determined rules discussed with regard to the mobile P2M system may also be included in the alias card P2M system.

If the banking system 600 determines that the transfer complies with the pre-determined rules, then in some embodiments the banking system 600 prompts the user to confirm the transaction, as depicted in block 814. In one embodiment, the banking system 600 and computer-implemented method prompts the user to confirm the transaction at the POS device 320a. For example, the POS device 320a may display a query asking whether the user 310 approves the transaction. The query may include the user's account type (e.g., checking or credit card) and the amount. In another embodiment, the banking system 600 and computer-implemented method prompts the user to confirm the transaction via the mobile device 400. For example, the user 310 may receive an automatically generated text message or email from the banking system 600 that asks the user 310 to respond to the message to confirm the transaction. It should be understood that other means for prompting the user to confirm the device are possible.

In some embodiments depicted in block 816, the user 310 confirms the transaction request. In an embodiment, the user 310 confirms the transaction request at the POS device 320a. For example, the user may select a “YES” button on a POS terminal to complete the transaction. In another embodiment, the user 310 confirms the transaction request using the mobile device 400, such as by sending an email or text message using the mobile device 400, or by activating an application on the mobile device. In some embodiments, the user 310 confirms the transaction because the transaction amount has changed due to taxes or fees associated with the purchase of a product or service. In a still further embodiment, the user 310 and/or financial institution establishes rules whereby the user 310 does not need to confirm the transaction if certain conditions apply. For example, the user 310 may not need to confirm the transaction if the transaction amount is below a certain amount, if the transaction is being conducted at specific merchants or in a specific location, or if the transaction is being conducted at a specific time. As should be understood, the user 310 may also cancel the transaction by not confirming the transaction request. The user may cancel the transaction for any reason.

The process then moves to block 818 where the banking system 600 uses the user's and the business's financial institution account numbers to initiate ACH or other type of transfer from the financial institution account associated with the user's (sender's) account number or alias to the business's account.

The process then moves to block 820 where the banking system 600 sends a message to the user with information regarding the transfer and with a message that the transfer completed successfully. For example, the banking system 600 may send a text message to the user indicating that the user has successfully transferred a sum of money to the business. The text message also provides the user with a confirmation number for the transfer. The banking system 600 may also send a confirmation to the business so that the business knows that the transaction completed successfully.

In a still further embodiment, the user transfers the user's alias to the business using a barcode displayed on the mobile device 400 rather than the alias card. The P2M system client application 694 creates barcodes on the screen of the mobile device. In an embodiment, the barcodes encode the user's alias. A variety of types of barcodes may be used. For example, UPC barcodes, QE codes, Aztec codes, Small Aztec codes, Intercodes, Maxicodes, PDF417 codes, Supercodes, etc., can be used. In an embodiment, the barcode is the alias. In another embodiment, the barcode encodes the user's phone number, email address, social networking ID, or other registered alias.

In an exemplary embodiment, the user activates the P2M system client application 694 at the business 320. The user 310 provides commands that cause the application to generate the user's barcode, such as by means of a GUI. The business 320 then scans the barcode and converts the barcode to the user's alias. In some embodiments, the business also provides the amount, as discussed previously. Once the business has the user's alias, the computer-implemented method is similar to the method depicted in blocks 806-820. The banking system 600 looks up the alias in the alias datastore, such as the alias datastore in the alias data repository 500; the account number associated with the alias is identified; the transaction is evaluated to determine whether pre-determined rules are complied with; the user confirms the transaction; and the transaction is completed. As should be understood, not all of these steps need to be performed for every transaction. For example, the user may instruct the banking system 600 that transaction less than $10 in amount do not need to be confirmed. In another embodiment, the user is able to change the barcode via the mobile device, an ATM, or online. Again, use of barcodes provides convenience and security to users because the barcodes do not contain account information and because the barcodes can be easily changed should they become public.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, optical fiber cable, radio frequency signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

We claim:

1. A computer-implemented method for conducting a financial transaction at a merchant, the method comprising:
receiving an alias, wherein the alias is associated with a party to the financial transaction, wherein the party is a user or a merchant;
determining, via a computing device processor, an account associated with the alias; and
conducting a financial transaction between the user and the merchant using the account.

2. The computer-implemented method according to claim 1, further comprising determining, via a computing device processor, an account number associated with the alias.

3. The computer-implemented method according to claim 1, wherein the alias is associated with the merchant.

4. The computer-implemented method according to claim 3, wherein the alias is a trademark, a social networking ID, a business category, a business location, a business name, a logo, a trade name, a service mark, or a URL associated with a website.

5. The computer-implemented method according to claim 4, wherein the alias is identified based at least in part on a location of the user.

6. The computer-implemented method according to claim 1, wherein the alias is received via a spoken command received through a microphone.

7. The computer-implemented method according to claim 1, further comprising determining an amount for the financial transaction.

8. The computer-implemented method according to claim 1, further comprising determining, via a computing device processor, if the financial transaction complies with a pre-determined rule.

9. The computer-implemented method according to claim 8, wherein the pre-determined rule determines whether the financial transaction may be completed based on a characteristic of the transaction.

10. The computer-implemented method according to claim 9, wherein the pre-determined rule is selected from the group consisting of an allowable amount, an allowable time of transaction, an allowable location of transaction, an allowable amount remaining in the account, and an allowable frequency of financial transaction.

11. The computer-implemented method according to claim 1, wherein the alias is associated with the user.

12. The computer-implemented method according to claim 11, wherein the alias is stored on a card.

13. The computer-implemented method according to claim 12, wherein the alias is stored on the card based on at least one of a magnetic strip, a computer-chip, and a printed code.

14. The computer-implemented method according to claim 11, wherein the alias is presented in a bar code displayed on a mobile device.

15. A computer program product for conducting a financial transaction at a merchant, the computer program product comprising a computer-readable medium having computer-executable instructions for performing:
receiving an alias, wherein the alias is associated with a party to the financial transaction, wherein the party is a user or a merchant;
determining, via a computing device processor, an account associated with the alias; and
conducting a financial transaction between the user and the merchant using the account.

16. The computer program product of claim 15, wherein the computer-readable medium has computer-executable instructions for determining the location of the user.

17. The computer program product of claim 16, wherein the computer-readable medium has computer-executable instructions for providing an alias for the merchant to the user based on the location of the user.

18. The computer program product of claim 15, wherein the computer-readable medium has computer-executable instructions for determining an account balance of the account after the financial transaction is completed.

19. The computer program product of claim 15, wherein the computer-readable medium determines, via a computing device processor, a financial account number associated with the account.

20. The computer program product of claim 15, wherein the computer-readable medium has computer-executable instructions for presenting confirmation that the transaction completed to the user or the merchant.

21. The computer program product of claim 15, wherein the computer-readable medium has computer-executable instructions for determining whether the transaction complies with a pre-determined rule.

22. The computer program product of claim 21, wherein the computer-readable medium cancels the transaction if the transaction does not comply with the pre-determined rule.

23. A system for conducting a financial transaction at a merchant, the system comprising:
a computer apparatus including a processor and a memory; and
a payment system module stored in the memory, executable by the processor and configured to:
receive an alias, wherein the alias is associated with a party to the financial transaction, wherein the party is a user or a merchant;
determine, via a computing device processor, an account associated with the alias; and
conduct a financial transaction between the user and the merchant using the account.

24. The system according to claim 23, further comprising an application on a mobile device of the user.

25. The system according to claim 24, wherein the mobile device is selected from a mobile computing device, a mobile phone, and a personal digital assistant.

26. The system according to claim 23, wherein the system further comprises a positioning system device on a mobile device of the user.

27. The system according to claim 23, wherein the payment system module is further configured to determine a financial account number for the account.

28. The system according to claim 23, wherein the payment system module is further configured to prompt the user to confirm the transaction.

29. The system according to claim 28, wherein the user is prompted to confirm the transaction via a mobile device of the user.

30. The system according to claim 28, wherein the payment system module is further configured to wirelessly transmit the alias for the user to the merchant.
